(19) United States
(12) Patent Application Publication
(10) Pub. No.: US 2010/0293761 A1
(43) Pub. Date: Nov. 25, 2010

(54) CLIP

(76) Inventors: Takashi Koike, Kanagawa (JP); Akira Yoneoka, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 12/735,497

(22) PCT Filed: Jan. 13, 2009
(86) PCT No.: PCT/JP2009/050292

§ 371 Date: Jul. 21, 2010

(30) Foreign Application Priority Data
Jan. 22, 2008 (JP) 2008-011130
Oct. 3, 2008 (JP) 2008-258716

(51) Int. Cl. F16B 2/20

(52) U.S. Cl. 24/458

(57) ABSTRACT

A clip is provided which can be brought into engagement with a mounting hole with a relatively low insertion force and which can be pulled out of the mounting hole for reuse. This clip includes a flange portion 16 which is brought into abutment with a front surface of a mounting hole, a stem portion 24 which hangs downwards from a rear surface of the flange portion 16, a pair of elastic engagement pieces 26, 26 which are extended from a distal end portion of the stem portion 24 so as to expand obliquely upwards towards the flange portion 16, and an expansion restriction which brings the elastic engagement pieces 26 into engagement with the stem portion 24 or the flange portion 16 while permitting the elastic engagement pieces 26 to deflect further inwards when the elastic engagement pieces 26 deflect inwards with a given angle. The elastic engagement pieces 26 deflect further inwards than an engagement position set by the expansion restriction mechanism so as to pass through the mounting hole 13 and expand again on a rear surface side of the mounting hole 13 so as to be brought into engagement with the mounting hole 13.

### TECHNICAL FIELD

The present invention relates to a clip having a flange portion adapted to be brought into abutment with a front surface of a mounting hole in a mount member, a stem portion which hangs downwards from a rear surface of the flange portion and a pair of elastic engagement pieces which are extended so as to be expanded obliquely upwards towards the flange portion from positions on a distal end portion of the stem portion which face each other in a circumferential direction, wherein by the stem portion and the elastic engagement pieces being inserted into the mounting hole, the elastic engagement pieces are deflected inwards so as to pass through the mounting hole to thereby be brought into engagement with the mounting hole on a rear surface side thereof.

### BACKGROUND ART

Clips which are formed from synthetic resins are used when automotive or electric equipment components that are to be assembled to the inside thereof are fastened to the body of an automobile or a panel portion of the body of electric equipment or when another panel is fastened to the panel portion in a face-to-face fashion.

As these clips, for example, Patent Document 1 below discloses a synthetic resin fastening tool having a head portion and a locking leg which hands downwards from a lower surface of the head portion and adapted to be fastened to a panel by the locking leg being pushed into a through hole in the panel, wherein the locking leg hangs straight downwards from a central portion of the lower surface of the head portion and four projecting pieces are provided on the locking leg portion along a lengthwise direction thereof so as to project radially outwards from a central portion thereof, wherein a substantial outside diameter which connects distal ends of the four projecting pieces together is made up of an axial core portion which is made smaller than a diameter of the through hole in the panel and four elastic locking pieces each of which is disposed between any two adjacent projecting pieces of the four projecting pieces with a required interval defined between the two adjacent projecting pieces and the elastic locking projecting piece disposed therebetween and which are integrated with the axial core portion by upper end portions thereof being joined to a proximal portion of the axial core portion or a lower surface of the head portion and lower end portions thereof being joined to a leg end of the axial core portion, and wherein the four elastic locking pieces have swollen portions formed on respective outer lateral surfaces of the four elastic locking pieces in an intermediate position along the length thereof, a substantial diameter which connects the respective swollen portions is made larger than the diameter of the through hole in the panel so that when the respective elastic locking pieces are contracted diametrically to pass through the through hole, the elastic locking pieces are allowed to be withdrawn into between the projecting pieces by making use of the intervals defined between the projecting pieces and themselves so as to be deflected towards the direction of the central portion for diametrical contraction and when the elastic locking pieces implement locking, the elastic locking pieces are allowed to be pushed out of between the projecting pieces by virtue of their elastic restoring force whereby the swollen portions are hooked on an edge of the through hole in the panel to be locked thereon.

In addition, Patent Document 2 below discloses a clip for mounting a given mounted member on a mount plate by making use of a mounting hole formed in the mount plate so as to pass therethrough from a front to a rear thereof, the clip comprising an engagement portion that is inserted into the mounting hole and an assembled portion that is assembled on to the given mounted member, wherein the engagement portion is made up of plural engagement pieces that can deflect elastically in a radial direction thereof and a holding portion for holding the engagement portion in an inserted state in the mounting hole with a prescribed resistance to load is provided on an outer surface of each of the engagement pieces at a proximal end side of the engagement portion, and wherein an external configuration of each engagement pieces is formed into a gradually changing plane which enables an abutment angle formed by the outer surface of each of the engagement pieces and an inner circumferential surface of the mounting hole to decrease gradually towards 0 degree within a range as each of the engagement pieces is brought into contact with an inner circumference of the mounting hole to thereby start its deflection when the engagement portion is inserted into the mounting hole, the range extending from a contact starting position where each of the engagement pieces starts to contact the inner circumference of the mounting hole to an arbitrary position including a position lying directly ahead of the holding portion.

Further, Patent Document 3 below discloses a clip having a head portion, a neck portion and a leg portion, wherein the leg portion comprises a strut which extends from a lower end face of the neck portion and a pair of elastic locking legs which extend slightly obliquely from a distal end of the strut in the direction of the neck portion, an engagement step portion being formed at a distal end portion of each of the elastic locking leg.

Patent Document 1: JP-3450342-B

Patent Document 2: JP-2001-182725-A

Patent Document 3: JP-2006-138466-A

### DISCLOSURE OF THE INVENTION

### Problem to be Solved by the Invention

However, the clips disclosed in Patent Document 1 and Patent Document 2 above have the construction in which the upper end portions of the elastic locking pieces are joined to the axial core portion or the lower surface of the head portion and the lower end portions of the elastic locking pieces are joined to the leg end of the axial core portion. According to this construction, there have been inherent drawbacks that the elastic locking pieces are made difficult to be deflected inwards when they are inserted into the mounting hole, which requires a large inserting force and that a sliding mold or the like is required, which makes the whole mold complex.

With the clip disclosed in Patent Document 3 above, the mold involved is relatively simple in construction. However, when attempting to reuse the clip by pulling it out after the clip has been brought into engagement with the mounting hole to be fixed therein, the elastic locking legs are deformed when they are pulled out. Thus, there has been an inherent drawback that the reuse of the clip is made difficult.

Consequently, an object of the invention is to provide a clip which can be brought into engagement with a mounting hole with a relatively small inserting force and which can be pulled out for reuse.

### Means for Solving the Problem

With a view to attaining the object, according to a first aspect of the invention, there is provided a clip comprising a flange portion which is brought into abutment with a front surface of a mounting hole, a stem portion which hangs downwards from a rear surface of the flange portion, at least a pair of elastic engagement pieces which are extended from a distal end portion of the stem portion so as to expand obliquely upwards towards the flange portion, and an expansion restriction mechanism which brings the elastic engagement pieces into engagement with the stem portion or the flange portion while permitting the elastic engagement pieces to deflect further inwards when the elastic engagement pieces deflect inwards with a given angle, wherein the elastic engagement pieces deflect further inwards than an engagement position set by the expansion restriction mechanism so as to pass through the mounting hole and expand again on a rear surface side of the mounting hole so as to be brought into engagement with the mounting hole.

According to the first aspect of the invention, when the elastic engagement pieces and the stem portion of the clip are inserted into the mounting hole, the elastic engagement pieces are brought into press contact with an inner circumference of the mounting hole to thereby be deflected inwards. Then, when the elastic engagement pieces deflect through the given angle, the elastic engagement pieces are brought into engagement with the stem portion or the flange portion by the expansion restriction mechanism. However, since the elastic engagement pieces are permitted to deflect further inwards, the elastic engagement pieces pass through the mounting hole to thereby be expanded again on the rear surface side of the mounting hole so as to be brought into engagement with the mounting hole.

As this occurs, since the elastic engagement pieces are connected to the stem portion only at the lower end portions thereof, the elastic engagement pieces can be deflected with a relatively weak force. Thus, by reducing the inserting force at which the elastic engagement pieces are inserted into the mounting hole for engagement therewith, the elastic engagement pieces can be inserted into the mounting hole with ease.

In addition, when the clip is pulled out of the mounting hole for some reason, since the elastic engagement pieces are restricted from being opened at the angle equal to or larger than the given angle by the expansion restriction mechanism, there is no such case that the elastic engagement pieces are opened outwards, and hence, the elastic engagement pieces can be deflected inwards so as to be pulled out of the mounting hole. Because of this, the deformation of the elastic engagement pieces are prevented, and therefore, the clip can be reused.

According to a second aspect of the invention, there is provided the clip of the first aspect of the invention, wherein a projecting piece is extended from the stem portion side along a plane on which one side of the elastic engagement piece moves when the elastic engagement piece deflects inwards, and wherein the expansion restriction mechanism includes an engagement recess which is formed on one of the projecting piece and the elastic engagement piece and an engagement projection which is formed on the other of the projecting piece and the elastic engagement piece so as to be brought into engagement with the engagement recess.

According to the second aspect of the invention, the stem portion can be reinforced by the projecting pieces. In addition, the projecting pieces can prevent the elastic engagement pieces from moving at least towards their corresponding projecting pieces in such a state that the elastic engagement pieces are in engagement with the mounting hole to be fixed therein.

According to a third aspect of the invention, there is provided the clip of the second aspect of the invention, wherein the engagement recess includes a through hole provided in the projecting piece, and wherein the engagement projection projects from one side of the elastic engagement piece towards the projecting piece side.

According to the third aspect of the invention, even in the event that the projecting piece is thin in thickness, the engagement projection can be firmly brought into engagement with the engagement recess by the engagement projection being inserted into the through hole.

According to a fourth aspect of the invention, there is provided the clip of the third aspect of the invention, wherein a catching portion is provided on an inner circumference of the through hole so as to protrude from an edge portion of the through hole which face the elastic engagement piece into an inside of the through hole, and wherein the engagement projection has a first engagement plane which is brought into engagement with the inner circumference of the through hole to restrict the expansion of the elastic engagement piece and a second engagement plane which is brought into engagement with the catching portion to restrict a shift of the elastic engagement piece in a direction substantially perpendicular to a diametrical direction of the elastic engagement piece.

According to the fourth aspect of the invention, since the expansion and shift in the direction perpendicular to the expanding direction of the elastic engagement piece can be restricted at the same time, the deformation of the elastic engagement piece can be prevented in such a state that the elastic engagement piece is in engagement with the mounting hole to be fixed therein, whereby the removal of the elastic engagement piece from the mounting hole can be prevented even though a force is applied to the elastic engagement piece from various direction.

According to a fifth aspect of the invention, there is provided the clip of the first aspect of the invention, wherein the expansion restriction mechanism is formed between an engagement wall which is extended from the flange portion and the elastic engagement piece.

According to the fifth aspect of the invention, since the elastic engagement piece is brought into engagement with the engagement wall extended from the flange portion, the expansion restriction mechanism can be simply provided.

According to a sixth aspect of the invention, there is provided the clip of the first aspect of the invention, wherein the stem portion includes four ribs which project radially outwards with respect to an axial center thereof, wherein each of the four elastic engagement pieces is disposed between any two adjacent ribs of the four ribs, and wherein the expansion restriction mechanism includes an engagement recess which is formed on one of the rib and the elastic engagement piece and an engagement projection which is formed on the other of the rib and the elastic engagement piece so as to be brought into engagement with the engagement recess.

According to the sixth aspect of the invention, since each of the four elastic engagement pieces is disposed between any two adjacent ribs of the four ribs, the four elastic engagement pieces are brought into engagement with a circumferential edge of the mounting hole with a relatively good balance. As a result, even in the event that a prying force is applied to the clip from any circumferential position thereof, the clip can be kept in stable engagement with the mounting hole while the loosening of the clip is prevented.

According to a seventh aspect of the invention, there is provided the clip of any of the first to sixth aspects of the invention, wherein a stem-portion-side first projection is formed so as to extend from the stem portion towards the elastic engagement piece, wherein an engagement-piece-side first projection is formed so as to extend from the elastic engagement piece towards the stem portion, and wherein, when the stem portion and the elastic engagement pieces are inserted into the mounting hole, the stem-portion-side first projection and the engagement-piece-side first projection are not brought into engagement with each other due to a position of the engagement-piece-side first projection being shifted from a position of the stem-portion-side first projection in an axial direction of the stem portion, while when a force is applied to pull out the stem portion and the elastic engagement pieces from the mounting hole, the stem-portion-side first projection and the engagement-piece-side first projection are brought into engagement with each other due to the length of the elastic engagement piece being shortened by the elastic engagement piece being bent.

According to the seventh aspect of the invention, when the stem portion and the elastic engagement pieces are inserted into the mounting hole, the stem-portion-side first projection and the engagement-piece-side first projection are not brought into engagement with each other due to the position of the engagement-piece-side first projection being shifted from the position of the stem-portion-side first projection in an axial direction of the stem portion. Therefore, the elastic engagement pieces are allowed to be contracted diametrically without an inward deflection of the elastic engagement pieces being restricted, whereby the stem portion and the elastic engagement pieces can be smoothly inserted into the mounting hole. In addition, when the force is applied to pull out the stem portion and the elastic engagement pieces from the mounting hole in such a state that the stem portion and the elastic engagement pieces are in engagement with the mounting hole, the stem-portion-side first projection and the elastic-engagement-piece side first projection are brought into engagement with each other due to the length of the elastic engagement piece being shortened by the elastic engagement piece being bent. Therefore, the inward deflection of the elastic engagement pieces is restricted, whereby a force can be increased which resists the removal of the stem portion and the elastic engagement pieces from the mounting hole.

According to an eighth aspect of the invention, there is provided the clip of the seventh aspect of the invention, wherein a stem-portion-side second projection is formed on the stem portion so as to extend towards the elastic engagement piece in a position lying closer to a distal end of the stem portion than the stem-portion-side first projection, wherein an engagement-piece-side second projection is formed on the elastic engagement piece in a position lying closer to a proximal end of the elastic engagement piece than the engagement-piece-side first projection, and wherein, when the elastic engagement piece is defected inwards, the engagement-piece-side second projection is disposed closer to the proximal end of the stem portion than the stem-portion-side second projection, while when the stem portion and the elastic engagement pieces are attempted to be forcibly pulled out of the mounting hole, the engagement-piece-side second projection is brought into abutment with the stem-portion-side second projection due to the length of the elastic engagement piece being shortened by the elastic engagement piece being bent.

According to the eighth aspect of the invention, when the stem portion and the elastic engagement pieces are attempted to be forcibly pulled out of the mounting hole, the engagement-piece-side second projection is brought into abutment with the stem-portion-side second projection due to the length of the elastic engagement piece being shortened by the elastic engagement piece being bent. Therefore, a further bending of the elastic engagement piece is suppressed, whereby damage to the elastic engagement pieces that would otherwise be made thereto when the clip is pulled out of the mounting hole can be reduced as much as possible.

According to a ninth aspect of the invention, there is provided the clip of the eighth aspect of the invention, wherein an abutment plane between the engagement-piece-side second projection and the stem-portion-side second projection is made into an inclined plane which is inclined radially outwards of the clip and gradually towards the proximal end of the stem portion.

According to the ninth aspect of the invention, when the stem portion and the elastic engagement pieces are attempted to be forcibly pulled out of the mounting hole, the engagement-piece-side second projection is brought into abutment with the stem-portion-side second projection due to the length of the elastic engagement piece being shortened by the elastic engagement piece being bent. In addition, due to the abutment plane being made into the inclined plane described above, the abutment force acts as a force which causes the elastic engagement piece to close inwards. Thus, a further bending of the elastic engagement piece is suppressed, whereby the clip can be smoothly pulled out of the mounting hole and with damage to the elastic engagement pieces that would otherwise be made thereto reduced to as low a level as possible.

### ADVANTAGE OF THE INVENTION

According to the clip of the invention, since the elastic engagement pieces are connected to the stem portion only at the lower end portions thereof, they can deflect inwards with the relatively weak force, and therefore, the insertion force with which the elastic engagement pieces are inserted into the mounting hole is made small so as to facilitate the insertion thereof into the mounting hole. In addition, when the clip needs to be pulled out of the mounting hole for some reason, since the elastic engagement pieces are restricted from expanding at the angle equal to or larger than the given angle, the elastic engagement pieces can deflect inwards without being opened outwards to thereby be removed from the mounting hole. Thus, since the deformation of the elastic engagement pieces is prevented, the clip can be reused.

### BEST MODE FOR CARRYING OUT THE INVENTION

Hereinafter, embodiments of a clip according to the invention will be described.

FIGS. 1 to 9 show a first embodiment of a clip according to the invention. As shown in FIG. 1, this clip 10 is used to fix a trim board 11 to a mounting hole 13 in a body panel 12.

The clip 10 has, from a top to a bottom thereof, a first flange portion 14, a second flange portion 15 and a third flange portion 16, and a head portion 17 includes these flange portions. Referring to FIG. 2 together, the first flange portion 14, the second flange portion 15 and the third flange portion 16 are connected together by neck portions 18. A taper surface 15a, which is inclined downwards, is provided on a circumferential edge of the second flange portion 15. In these flange portions, the third flange portion 16, which is brought into abutment with the body panel 12, configures a flange portion according to the invention.

A leg portion 19 is provided on a lower surface of the lowest third flange portion 16. On the other hand, a frame portion 22 is formed on the trim board 11 which includes at least a pair of side walls 20, 20 which hand downwards from a lower surface thereof and a bottom wall 21 which is provided at lower end portions of the side walls 20. An insertion groove 23 is formed in the bottom wall 20, and a deeper part of the insertion groove 23 is formed into diametrically expanded portion.

The clip 10 is attached to the trim board 11 by the neck portion 18 being inserted into the insertion groove 23, the first flange portion 14 being inserted into an inside of the frame portion 22, and the bottom plate 21 being held by the first flange portion 14, the second flange portion 15 and the third flange portion 16 therebetween. As this occurs, the insertion of the first flange portion 14 is facilitated by the taper surface 15a of the second flange portion 15, and the removal of the clip 10 from the insertion groove 23 is prevented by the neck portion 18 being fitted in the diametrically expanded portion 23a.

After the clip 10 is attached to the trim board 11 in the way described above, the leg portion 19 is inserted into the mounting hole 13, whereby the leg portion 19 is brought into engagement with the mounting hole 13 so that the trim board 11 is fixed to the body panel 12.

Further, referring to FIGS. 3A and 3B together, the leg portion 19 has a stem portion 24 which hangs downwards from a center of the lower surface of the third flange portion 16 into a plate-like shape. A distal end portion 25 is provided at a lower end of the stem portion 24, and the distal end portion 25 is formed into something like a rounded apex portion of a circular conical body. A proximal end face 25a of the distal end portion 25 expands into a circular disk shape from the lower end of the stem portion 24.

Elastic engagement pieces 26, 26 are extended from two portions on the proximal end face 25a which face each other in a circumferential direction across the stem portion 24 so as to expand obliquely upwards towards the third flange portion 16. Each elastic engagement piece 26 has a projecting portion 26a which projects farthest in a radially outward direction, an engagement step portion 26b which is inclined radially inwards from the projecting portion 26a, and a mounting hole inserting portion 26c which projects in an extending direction of the elastic engagement piece 26 from an upper end of the engagement step portion 26b.

In addition, a radially inward projecting portion 26d is provided at an upper end portion of the elastic engagement piece 26 so as to be extended towards the stem portion 24 side. A projecting piece 27 is extended towards each elastic engagement piece 26 from the stem portion 24 side along a plane on which one side of the elastic engagement piece 26 moves when the elastic engagement piece 26 deflects inwards. A through hole 28 is provided in an upper portion of each projecting piece 27. A catching portion 29 is provided on an inner circumference of the through hole 28 so as to protrude from an edge portion of the elastic engagement piece 26 into an inside of the through hole 28 along a surface of the projecting piece 27.

On the other hand, an engagement projection 30 is formed on the elastic engagement piece 26 so as to project towards the projecting piece 27 side. As shown in FIG. 6, a taper plane 30a is formed on the engagement projection 30 at a portion which corresponds to an inner corner portion of the elastic engagement piece 26. In addition, a first engagement plane, which is brought into engagement with the inner circumference of the through hole 28, is provided on a radially outer side of the engagement projection 30. A taper plane 32 is formed at a distal end portion of the projecting piece 27 in a direction in which the projecting piece 27 projects so as to be inclined in the same direction as a direction in the taper plane 30a is tapered. Further, as shown in FIG. 8, an outer circumferential surface, 33 of the projecting piece 27 is formed into an arc-like shape which matches the inner circumference of the mounting hole 13 in such a state that the leg portion 19 is in engagement with the mounting hole 13. As shown in FIGS. 5A, 5B and 7, a claw portion 31 is provided at a lower end of a projecting side of the engagement projection 30 to project so as to be brought into engagement with the catching portion 29 of the projecting piece 27.

Note that in this embodiment, the through hole 28 and the engagement projection 30 configure the expansion restriction mechanism of the invention.

Next, how to use this clip 10 will be described.

In using the clip 10, the clip 10 is attached to the frame portion 22 of the trim board 11 in the manner described above. Then, the leg portion 19 of the clip 10 is inserted into the mounting hole 13 in the body panel 12. Then, the pair of elastic engagement pieces 26 are pressed by the inner circumference of the mounting hole 13 to thereby deflect inwards. As this occurs, the taper planes 30a of the elastic engagement pieces 26 are brought into abutment with the corresponding taper planes 32 of the projecting pieces 27. Then, as shown in FIG. 6, the elastic engagement pieces 26 deflect in a width direction and ride over the taper planes 32 to thereby be brought into engagement with the corresponding through holes 28 in the engagement projections 30.

As this occurs, as shown in FIG. 7, the claw portions 31 which project downwards from the engagement projections 30 ride over the corresponding catching portions 29 which are formed on the inner circumferences of the corresponding through holes 28 of the projecting pieces 27 to thereby fit in the through holes 28 to a side of the catching portions 29. As a result, since the first engagement planes 30b shown in FIG. 6 are brought into engagement with the inner circumferences of the corresponding through holes 28, a radially outward shift of the elastic engagement pieces 26 is restricted. In addition, the second engagement planes 31a shown in FIG. 7 are brought into engagement with the corresponding catching portions 29, a shift of the elastic engagement pieces 26 in a direction substantially perpendicular to a direction in which the elastic engagement pieces 26 expand diametrically is restricted.

As is indicated by imaginary lines in FIG. 8, the elastic engagement pieces 26 are allowed to deflect further radially inwards from the aforesaid state. Namely, the elastic engagement pieces 26 deflect further inwards as is indicated by the imaginary lines in FIG. 8, and the projecting portions 26a can pass through the inner circumference of the mounting hole 13. When the projecting portions 26a of the elastic engagement pieces 26 pass through the mounting hole 13, the elastic engagement pieces 26 expand radially outwards again, whereby the elastic engagement pieces 26 are brought into engagement with a rear surface side of the mounting hole 13. The third flange portion 16 is brought into engagement with a front surface side of the body panel 12 to thereby hold the body panel 12 between the engagement step portions 26 of the elastic engagement pieces 26 and itself. Since the third flange portion 16 has a pad-like shape which expands in a skirt-like fashion, the third flange portion 16 is closely attached to the front surface of the body panel 12 in an elastic fashion so as to fix the clip 10 to the body panel 12 without any looseness.

The trim board 11 can be mounted on the body panel 12 via the clip 10 and the frame portion 22 in the way described above.

In this embodiment, since the distal end portion 25, which is rounded into the curved surface which tapers, is provided at the lower end portion of the stem portion 24, even in the event that burrs produced at the time of machining remain on the inner circumference of the mounting hole 13, the leg portion 19 can be inserted into the mounting hole 13 relatively easily without increasing the insertion resistance of the leg portion 19.

The elastic engagement pieces 26 are connected to the lower end portion of the stem portion 24 at their lower end portions via the distal end portion 25. Therefore, the elastic engagement pieces 26 are allowed to deflect inwards with a relatively weak force, thereby making it possible to reduce the insertion resistance of the leg portion 19. Thus, as shown in FIG. 7, both side surfaces 34 of the stem portion 24, outer circumferences of the elastic engagement pieces 26 and the outer circumferential surfaces 33 of the projecting pieces 27 are in abutment with the inner circumference of the mounting hole 13 in such a state that the clip 10 is fixed in the mounting hole 13. Therefore, the clip 10 is fixed without any looseness with respect to the mounting hole 13. Thus, even in the event that a lateral external force is applied to the clip 10, the deformation of the elastic engagement pieces 26 is prevented, whereby the elastic engagement pieces 26 can impart a sufficient fixing force.

Next, a case will be described in which the trim board 11 has to be removed from the body panel 12, for example, to repair an interior wiring inside the trim board 11.

When such a repair is required, the trim board 11 is pulled outwards so that the leg portion 19 of the clip 10 is forcibly pulled out of the mounting hole 13 in the body panel 12. As this occurs, in the clip 10, as shown in FIG. 6, the engagement projections 30 of the elastic engagement pieces 26 are in engagement with the through holes 28 in the projecting pieces 27 to thereby be restricted from moving outwards. Therefore, the elastic engagement pieces 26 are restricted from being opened outwards and deflect inwards along the inclined surfaces of the engagement step portions 26b, so that the projecting portions 26a are allowed to pass through the mounting hole 13, whereby the leg portion 19 can be pulled out of the mounting hole 13.

In this way, since the leg portion 19 is pulled out of the mounting hole 13 only by the inward deflection of the elastic engagement pieces 26, damage can be prevented which would otherwise be made to the clip 10 when it is pulled out of the mounting hole 13. Thus, the clip 10 can be reused in fixing the trim board 11 to the body panel 12 again.

FIGS. 10 to 13 show a second embodiment of a clip according to the invention. Like reference numerals will be imparted to portions which are substantially like to those described in the first embodiment, and the description thereof will be omitted here.

This clip 40 differs from the clip 10 of the first embodiment in the construction of the mechanism to restrict an expansion of an elastic engagement piece 26 at an angle equal to or larger than a given angle by being brought into engagement with the elastic engagement piece 26 when it deflects inwards.

As shown in FIGS. 10, 11A and 11B, this clip 40 has projecting ribs 41 which are provided at both sides of a stem portion 24 so as to project in opposite directions along a circumferential direction. As shown in FIG. 13, an outer circumferential surface 41a of the projecting rib 41 is formed into an arc-like shape which follows an inner circumference of a mounting hole 13 in such a state that the clip 40 is brought into engagement with the mounting hole 13 to be fixed therein.

Engagement walls 42 are provided on a lower surface of a third flange portion 16 so as to project a given length therefrom. As shown in FIG. 13, two engagement walls 42 are provided so as to overlap one side of corresponding elastic engagement pieces 26 while lying to face each other in the circumferential direction. The engagement wall 42 has a sectional configuration which is surrounded by an inner surface 42a which is substantially parallel to the stem portion 24, an outer surface 42b which is formed into a shape which follows the inner circumference of the mounting hole 13, and a taper plane 44c which is inclined obliquely towards a diametrically inner side.

On the other hand, a projecting portion 43 is provided on one side of an upper end portion of each of the elastic engagement pieces 26. Then, a claw portion 44, which is brought into engagement with the engagement wall 42 which extends from the third flange portion 16, is provided at a corner portion of an inner surface of the projecting portion 43. A taper plane 44a is formed on an inner surface of the claw portion 44 so as to be brought into sliding contact with the taper plane 42c of the engagement wall 42, whereby when the elastic engagement piece 26 is caused to deflect inwards, the claw portion 44 is smoothly brought into engagement with the engagement wall 42.

A cutout portion 45 is provided on the other side of the upper end portion of the elastic engagement piece 26, so that when the elastic engagement piece 26 is caused to deflect inwards, the engagement wall 42 passes through the cutout portion 45 so as to be brought into engagement with the claw portion 44.

Also, in this state, as shown in FIG. 13, the elastic engagement piece 26 is allowed to deflect further radially inwards from a state in which the claw portion 44 is brought into engagement with the engagement wall 42. Consequently, the elastic engagement pieces 26 deflect further inwards from the state shown in FIG. 13 by the leg portion 19 of the clip 40 being pushed into the mounting hole 13 in a body panel 12, whereby projecting portions 26a pass through the mounting hole 13, and the elastic engagement pieces 26 expand diametrically again so as to be brought into engagement with a rear surface side of the mounting hole 13. Thus, the clip 40 is fixed to the body panel 12.

Then, in the event that the clip 40 has to be pulled out of the mounting hole 13 for the reason described before, the elastic engagement pieces 26 deflect inwards again by the trim board to which the clip 40 is attached being pulled, whereby the clip 40 can be pulled out of the mounting hole 13 without being damaged in any way. Namely, in this embodiment, too, since the elastic engagement pieces 26 which deflect inwards when they are inserted into the mounting hole 13 are restricted from being expanded at an angle equal to or larger than a given angle by the engagement between the claw portions 44 and the engagement walls 42, there is no such case that the elastic engagement pieces 26 expand outwards when the pulling force is applied to the clip 40. Thus, the elastic engagement pieces 26 can smoothly deflect inwards to thereby pass through the mounting hole 13.

In this embodiment, the engagement walls 42 and the claw portions 44 configure the expansion restriction mechanism of the invention.

FIGS. 14 to 16B show a third embodiment of a clip according to the invention. Like reference numerals will be imparted to portions which are substantially like to those described in the first embodiment, and the description thereof will be omitted here.

In this clip 50, projecting pieces 51 extend from both surfaces of a stem portion 24 towards one side of elastic engagement pieces 26. Engagement projections 52 are provided at distal end portions of the projecting pieces 51 so as to project towards one side of the corresponding elastic engagement pieces 26. Taper planes 52a are formed at distal end portions of the engagement projections 52 (refer to FIG. 16B). On the other hand, projecting portions 53 are formed on one side of the elastic engagement pieces 26 which faces the corresponding projecting piece 51 so as to extend radially inwards, and engagement recesses 54 are formed on one side of the projecting portions 53 which faces the corresponding projecting piece 51.

Consequently, when the elastic engagement pieces 26 are caused to deflect inwards from a state shown in FIGS. 14, 15A and 15B, the taper planes 52a of the engagement projections 52 are brought into engagement with the projecting portions 53 so as to deflect slightly the corresponding elastic engagement pieces 26 in a width direction, whereafter the engagement projections 52 are brought into engagement with the corresponding engagement recesses 54 of the elastic engagement pieces 26. Thus, by the engagement projections 52 being brought into engagement with the corresponding engagement recesses 54, the elastic engagement pieces 26 are restricted from expanding radially outwards at an angle equal to or larger than an angle defined by the engagement of the engagement projections 52 with the corresponding engagement recesses 54. This state is shown in FIGS. 16A and 16B. Since the elastic engagement pieces 26 can deflect further inwards from the state shown in FIGS. 16A and 16B, projecting portions 26a of the elastic engagement pieces 26 can pass through amounting hole 13 so that engagement step portions 26b can be brought into engagement with a rear surface side of the mounting hole 13.

In this clip 50, too, in the event that the clip 50 has to be pulled out of the mounting hole 13 for some reason, the elastic engagement pieces 26, whose expansion is restricted by the engagement between the engagement projections 52 and the engagement recesses 54, deflect inwards by the clip 50 being pulled, whereby the clip 50 can be pulled out of the mounting hole 13 without being damaged in any way.

In this embodiment, the engagement recesses 54 and the engagement projections 52 configure the expansion restriction mechanism of the invention. In addition, in this embodiment, while the engagement recesses 54 are provided on the elastic engagement pieces 26 and the engagement projections 52 are provided on the projecting pieces 51, a configuration may be adopted in which the engagement projections are provided on the elastic engagement pieces 26 and the engagement recesses are provided on the projecting pieces 51.

In this way, according to the clip of the invention, since the elastic engagement pieces 26 are connected to the stem portion 24 only at the lower end portions thereof, the insertion force with which the elastic engagement pieces 26 are inserted into the mounting hole 13 can be made relatively small. In addition, in the event that the clip has to be pulled out of the mounting hole 13 for some reason, since the expansion of the elastic engagement pieces 26 at the angle equal to or larger than the given angle is restricted by the respective engagement mechanism that have been described above, the elastic engagement pieces deflect inwards without being opened outwards, and hence, the clip can be pulled out of the mounting hole 13 without being damaged in any way. Consequently, the clip that has been so removed can be reused.

FIGS. 17 to 19B show a fourth embodiment of a clip according to the invention. Like reference numerals will be imparted to portions which are substantially like to those described in the embodiments, and the description thereof will be omitted here.

This clip 60 differs from the clips of the first to third embodiments in the configuration of a stem portion 24 and the number of elastic engagement pieces 26. Namely, as shown in FIG. 18B, a stem portion 24 of this clip 60 includes four ribs 61 which project radially outwards with respect to an axial center C1 thereof along planes which are parallel to planes which pass through the axial center C1. A thickness center C2 of each rib 61 is offset with respect to the axial center C1 of the stem portion 24. The ribs 61 are disposed at angular intervals of 90 degrees. Then, four elastic engagement pieces 26 are disposed so that one elastic engagement piece 26 lies between any two adjacent ribs 61, 61 in a circumferential direction.

Further, an engagement wall 62 is provided to project at an upper portion (a proximal end portion in an axial direction) on a surface of each rib 61 which is opposite to a direction in which the rib 61 is offset with respect to the axial center C1 of the stem portion 24. Additionally, a presser wall 63 is provided to project below the engagement wall 62 so as to be substantially perpendicular to the engagement wall 62. The engagement wall 62 and an inside portion of the presser wall 63 configure an engagement recess 65 (refer to FIGS. 17 and 18A). A taper plane 62a is formed at a radially outward distal end portion of the engagement wall 62 so as to be gradually reduced in height as the rib 61 projects radially outwards (refer to FIG. 18B).

On the other hand, an engagement projection 67 is provided at an upper end portion of each elastic engagement piece 26 so as to project therefrom towards the corresponding rib 61 (refer to FIG. 18B).

Consequently, when the four elastic engagement pieces 26 are caused to deflect radially inwards from a state shown in FIGS. 18A and 18B, taper planes 67a of the engagement projections 67 are pressed by the taper planes 62a of the corresponding engagement walls 62, whereby the elastic engagement pieces 26 are caused to deflect slightly in a width direction. Thereafter, the engagement projections 67 enter the corresponding engagement recesses 65, whereby the engagement projections 67 are brought into engagement with the engagement walls 62 which constitute part of inner surfaces of the engagement recesses 65. This state is shown in FIGS. 19A and 19B.

A radially outward movement of each elastic engagement piece 26 is restricted by the engagement projection 67 being brought into engagement with the engagement recess 65 in the way described above. In the state shown in FIGS. 19A and 19B in which the engagement projections 67 are in engagement with their corresponding engagement recesses 65, the elastic engagement pieces 26 are allowed to deflect further radially inwards. Because of this, respective projecting portions 26a of the elastic engagement pieces 26 can pass through amounting hole 13 so that the four elastic engagement pieces 26 can be brought into engagement with a rear surface side of the mounting hole 13 at their engagement step portions 26b (refer to an imaginary line in FIG. 19B).

Then, in this embodiment, the four elastic engagement pieces 26 are disposed so that each elastic engagement piece 26 lies between any two adjacent ribs 61 of the four ribs 61 of the stem portion 24. Therefore, these four elastic engagement pieces 26 can be brought into engagement with a circumferential edge of the rear side of the mounting hole 13 with a relatively good balance. As a result, even in the event that a prying force is applied to the clip 60 from any circumferential position thereof, the loosening of the clip can be suppressed effectively, whereby the clip 60 can be stably brought into engagement with the mounting hole.

In this clip 60, too, when the clip 60 is pulled out of the mounting hole 13, the elastic engagement pieces 26 deflect radially inwards without being damaged in any way by the clip 60 being pulled so as to be pulled out of the mounting hole 13.

In this embodiment, the engagement recesses 65 and the engagement projections 67 configure the expansion restriction mechanism of the invention. In addition, in this embodiment, the engagement projection 67 is provided on the elastic engagement piece 26 and the engagement recess 65 is provided on the rib 61. However, a configuration may be adopted in which the engagement recess is provided on the elastic engagement piece 26 and the engagement projection is provided on the rib 61. Further, the engagement recess may be a through hole.

FIGS. 20 to 24 show a fifth embodiment of a clip according to the invention. Like reference numerals will be imparted to portions which are substantially like to those described in the previous embodiments, and the description thereof will be omitted here.

Basically, this clip 70 has the same construction as that of the clip 10 of the first embodiment shown in FIGS. 1 to 9 but differs therefrom in that plural projections are provided on both a stem portion 24 and elastic engagement pieces 26.

Namely, stem-portion-side first projections 71, 71 are provided at proximal end portions (upper end portions) on both surfaces of a stem portion 24 so as to project therefrom towards a pair of elastic engagement pieces 26. Further, engagement-piece-side first projections 72, 72 are provided on inner surface sides of distal end portions (upper end portions) of the pair of elastic engagement pieces 26, 26 so as to project therefrom towards both the surfaces of the stem portion 24. The engagement-piece-side first projection 72 corresponds to the radially inward projecting portion 26d of the clip 10 of the first embodiment. However, the different reference numeral is imparted thereto for description as a matter of conveniences.

As shown in FIG. 22, when the stem portion 24 and the elastic engagement pieces 26 are inserted into a mounting hole 13, outer surfaces of the elastic engagement pieces 26 are pressed against by an inner circumference of the mounting hole to thereby deflect radially inwards, while slightly extending in an axial direction. On the other hand, as shown in FIG. 24, when a pulling force is applied to the clip 70 attempting to remove it from the mounting hole 13 in such a state that the elastic engagement pieces 26 are in engagement with a circumferential edge of a rear side of the mounting hole 13, engagement step portions 26b of the elastic engagement pieces 26 are pressed by the circumferential edge of the rear side of the mounting hole 13, whereby the elastic engagement pieces 26 are slightly curved so as to be compressed in the axial direction, and the projecting length of the elastic engagement pieces 26 is slightly shortened.

The stem-portion-side first projections 71 and the engagement-piece-side first projections 72 are not brought into abutment with each other due to both the first projections 71, 72 being shifted from each other in the axial direction of the stem portion by the extension of the elastic engagement pieces 26 when the stem portion 24 and the elastic engagement pieces 26 are inserted into the mounting hole 13 (refer to FIG. 22). When a force is applied to the clip 70 to pull out the stem portion 24 and the elastic engagement pieces 26 from the mounting hole 13, the stem-portion-side first projections 71 and the engagement-piece-side first projections 72 are brought into abutment with each other due to the elastic engagement pieces 26 being shortened in length as a result of them being bent (refer to FIG. 24). In this embodiment, the stem-portion-side first projections 71 and the engagement-piece-side first projections 72 are made not to be brought into abutment with each other by the extension of the elastic engagement pieces 26 when the stem portion 24 and the elastic engagement pieces 26 are inserted into the mounting hole 13. However, the stem-portion-side first projections 71 and the engagement-piece-side first projections 72 may be disposed so as to be offset from each other in the axial direction of the stem portion 24 in advance so that they do not overlap each other.

Further, stem-portion-side second projections 73, 73 are provided on both the surfaces of the stem portion 24 at portions which lie closer to distal end portions (lower end portions) than the stem-portion-side first projections 71 so as to project obliquely upwards and outwards towards the pair of elastic engagement pieces 26, 26. In addition, engagement-piece-side second projections 74, 74 are provided on inner surface sides of portions of the pair of elastic engagement pieces 26, 26 which lie closer to proximal end portions than the engagement-piece-side first projections 72 (here, in a substantially intermediate position along a projecting length of the elastic engagement piece 26) the so as to project obliquely downwards and inwards towards the stem portion 24.

Then, the stem-portion-side second projections 73 and the engagement-piece-side second projections 74 are configured as follows. When the elastic engagement pieces 26 are caused to deflect inwards, the engagement-piece-side second projections 74 are disposed closer to the proximal end portion than the stem-portion-side second projections 73 (refer to FIGS. 22 and 23). When the stem portion 24 and the elastic engagement pieces are pulled out of the mounting hole 13, the engagement-piece-side second projections 74 are brought into engagement with the stem-portion-side second projections 73 due to the elastic engagement pieces 26 being shortened in length as a result of them being bent (refer to FIG. 24).

As has been described above, when the elastic engagement pieces 26 are bent, lower surfaces (surfaces facing the stem-portion-side second projections 73) of the engagement-piece-side second projections 74 are brought into engagement with upper surfaces (surfaces facing the engagement-piece-side second projections 74) of the stem-portion-side second projections 73. These surfaces configure the “abutment plane” of the invention. This abutment plane 75 is formed into an inclined plane which is inclined gradually towards a proximal portion side of the stem portion 24.

When the pair of elastic engagement pieces 26, 26 of the clip 70 which is constructed as described above are caused to deflect inwards, as with the clip 10 of the first embodiment, engagement projections 30 fit in through holes 28, whereby not only is a radially outward movement of the elastic engagement pieces 26 restricted, but also the elastic engagement pieces 26 are still allowed to deflect further inwards.

Then, when the stem portion 24 and the elastic engagement pieces 26 continue to be inserted into the mounting hole 13, as shown in FIG. 22, the elastic engagement pieces 26 are pressed by the inner circumference of the mounting hole 13 and deflect radially inwards to thereby be inserted into the mounting hole 13 while being caused to extend slightly in the axial direction. As this occurs, in the clip 70, since the stem-portion-side first projections 71 and the engagement-piece-side first projections 72 are brought into abutment with each other, the elastic engagement pieces 26 are allowed to be contracted diametrically without the inward deflection of the elastic engagement pieces 26 being restricted, whereby the elastic engagement pieces 26 can be smoothly inserted into the mounting hole 13.

When projecting portions 26a of the elastic engagement pieces 26 pass through the mounting hole 13, the elastic engagement pieces 26 are allowed to expand radially outwards again, and as shown in FIG. 23, the engagement step portions 26b are brought into engagement with the rear surface side of the mounting hole 13, whereby the clip 70 is fixed in place in the mounting hole 13.

When an unexpected pulling force is applied to the stem portion 24 and the elastic engagement pieces 26 of the clip 70 in such a state that the elastic engagement pieces 26 are in engagement with the mounting hole 13 in the way described above, the engagement step portions 26b of the elastic engagement pieces 26 are pressed against the circumferential edge of the rear side of the mounting hole 13, whereby the elastic engagement pieces 26 are bent slightly inwards to thereby be shortened in length. However, as this occurs, inner surfaces of the engagement-piece-side first projections 72 are brought into abutment with outer surfaces of the stem-portion-side first projections 71, whereby the inward deflection of the elastic engagement pieces 26 is restricted (refer to FIG. 24). As a result, since the force can be increased which prevents the removal of the elastic engagement pieces 26 from the mounting hole 13, even in the event that the unexpected force is applied to the clip 70, the clip 70 is allowed to remain in the mounting hole 13 in a firmly fixed state.

Incidentally, when the clip 70 has to be removed from the mounting hole 13 for some reason such as repair, the stem portion 24 and the elastic engagement pieces 26 are forcibly pulled out of the mounting hole 13 as indicated by an arrow in FIG. 24 with a strong pulling force. As this occurs, as has been described before, since the engagement-piece-side second projections 74 are brought into abutment with the stem-portion-side second projections 73 due to the elastic engagement pieces 26 being shortened in length as a result of them being bent, further bending of the elastic engagement pieces 26 is suppressed, whereby damage can be reduced to as low a level as possible which would otherwise be made thereto when the clip 70 is pulled out of the mounting hole 13.

In addition, when the clip 70 is forcibly pulled out of the mounting hole 13, since the abutment plane 75 between the engagement-piece-side second projection 74 and the stem-portion-side second projection 73 is formed into the inclined plane which is inclined gradually towards the proximal portion side of the stem portion 24, the pulling force which is being applied to the clip 70 acts as a force which closes the elastic engagement piece 26 inwards. As a result, outward bending of the elastic engagement piece 26 can be suppressed more effectively, whereby the clip 70 can be pulled out of the mounting hole 13 smoothly and so as to reduce damage to the elastic engagement piece 26 to as low a level as possible.

In the fifth embodiment, as with the first embodiment, the through holes 28 and the engagement projections 30 configure the expansion restriction mechanism of the invention.

### BRIEF DESCRIPTION OF THE DRAWINGS

FIG. 1 is an explanatory diagram depicting a state in which a trim board is fixed to a body panel by use of a clip according to a first embodiment of the invention.

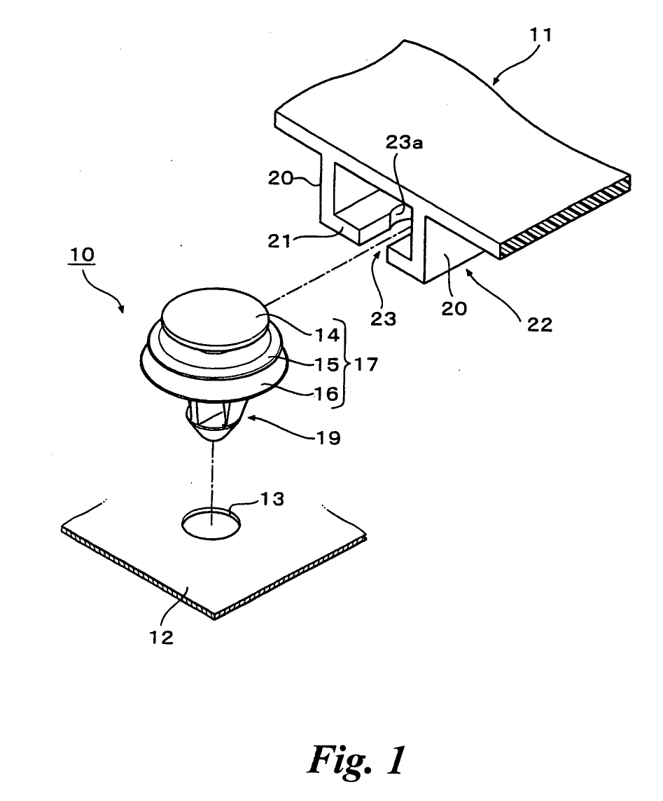

FIG. 2 is a partially cutaway perspective view of the clip.

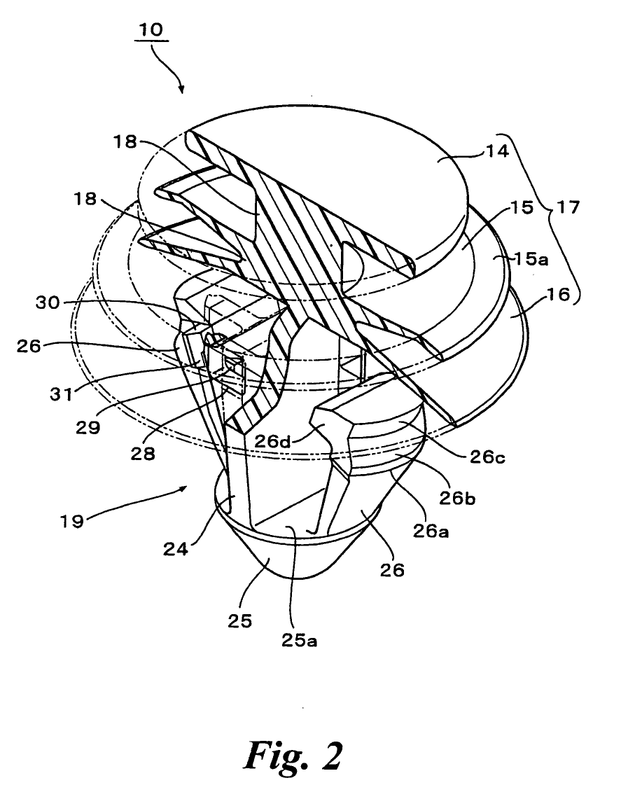

FIG. 3A is a front view of the clip, and FIG. 3B is a side view of the clip.

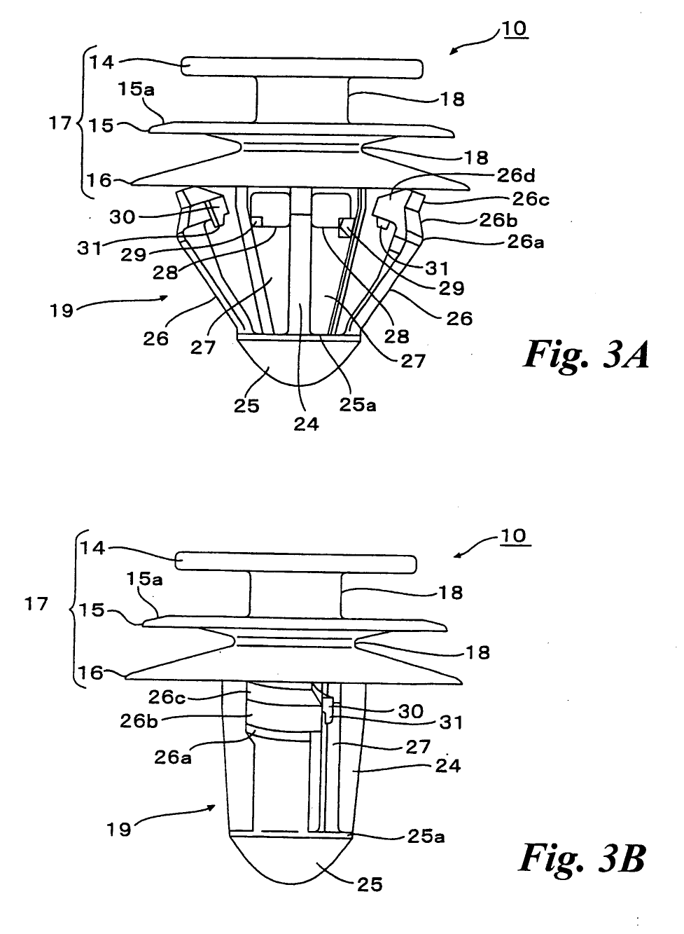

FIG. 4 is a partially cutaway perspective view of the clip in such a state that elastic engagement pieces are caused to deflect inwards so as to be brought into engagement with projecting pieces of a stem portion.

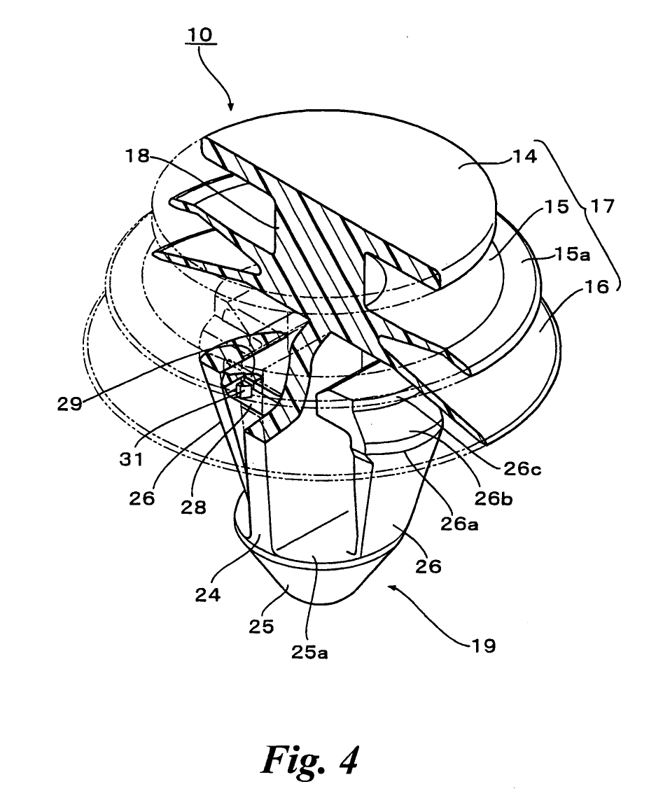

FIGS. 5A and 5B show the clip in the state shown in FIG. 4, of which FIG. 5A is a front view of the clip and FIG. 5B is a side view of the clip.

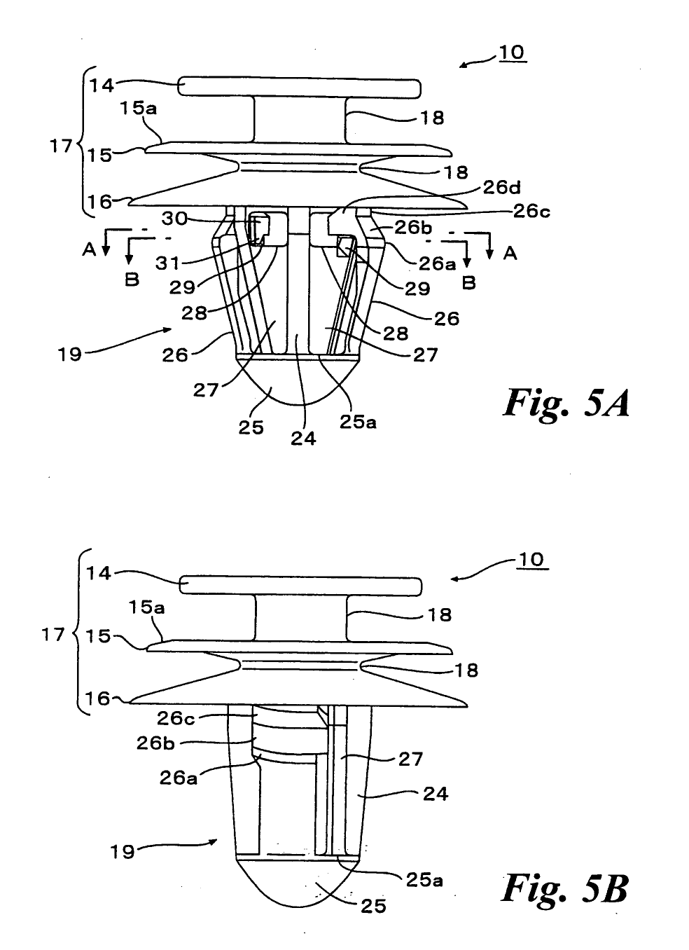

FIG. 6 is an explanatory diagram showing a state in which the elastic engagement pieces are brought into engagement with the projecting pieces of the stem portion in the clip.

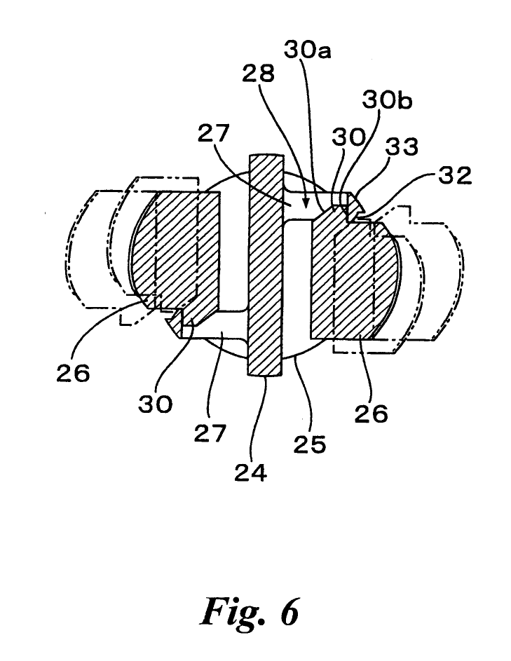

FIG. 7 is a sectional of the clip view taken along the line B-B and seen in a direction indicated by arrows attached thereto in FIGS. 5A and 5B.

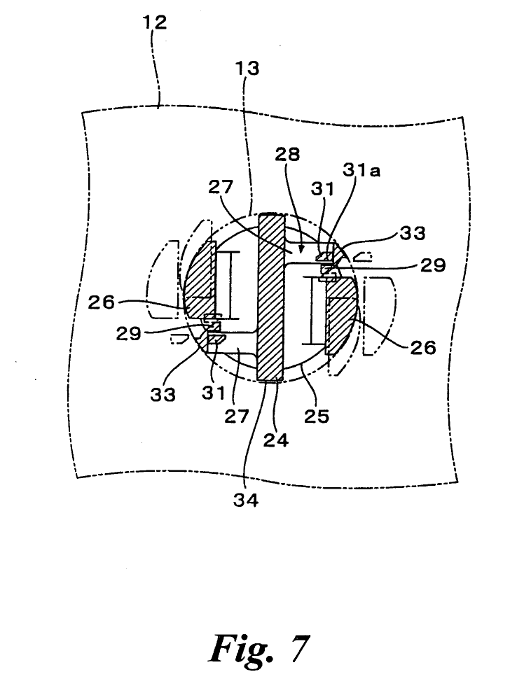

FIG. 8 is a sectional view of the clip taken along the line A-A and seen in a direction indicated by arrows attached thereto in FIGS. 5A and 5B.

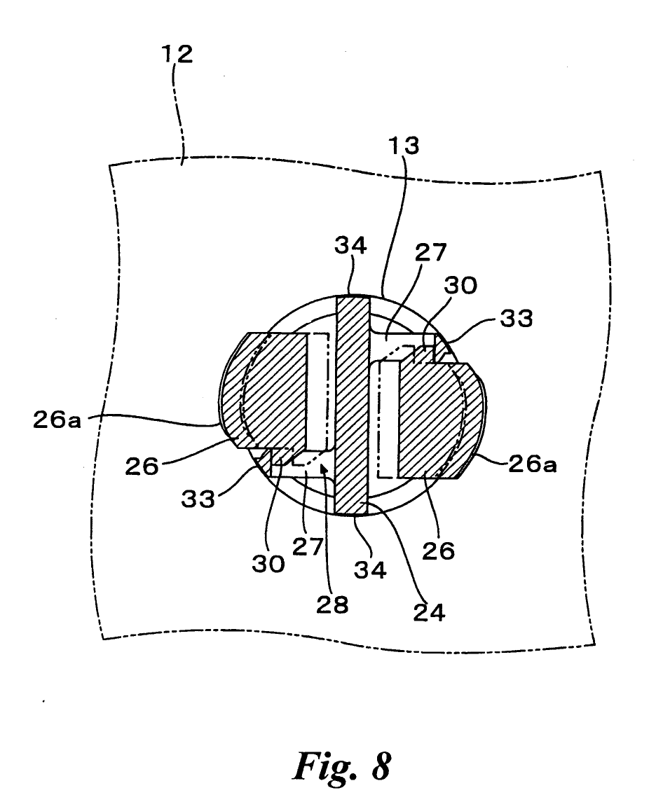

FIG. 9 is a sectional view showing a state in which a trim board is fixed to a body panel with the clip.

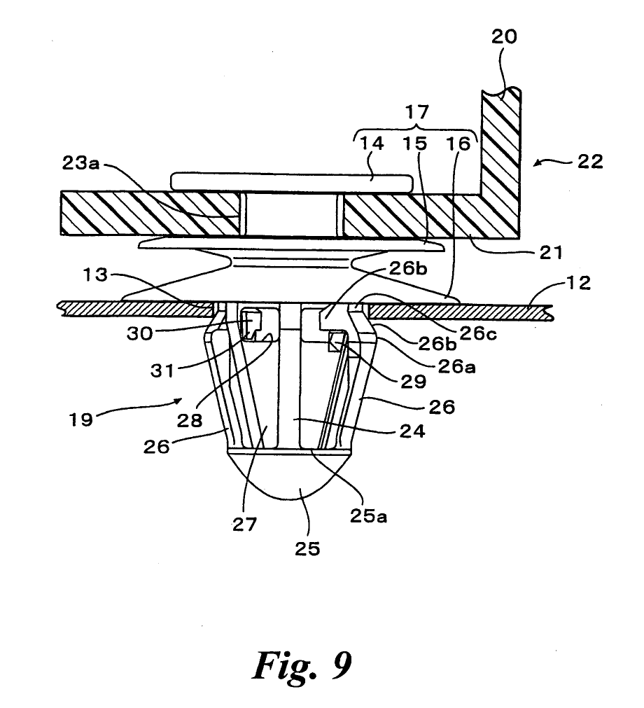

FIG. 10 is a partially cutaway perspective view of a clip according to a second embodiment of the invention.

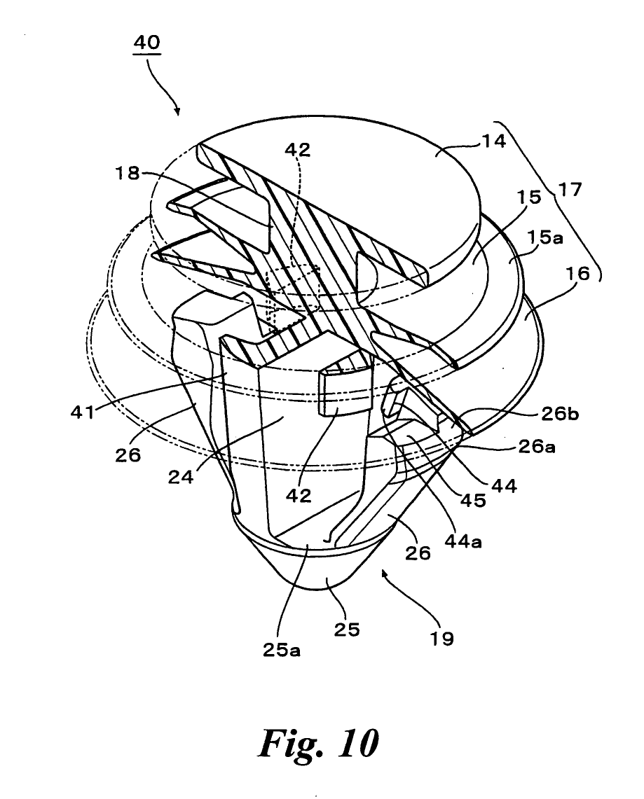

FIG. 11A is a front view of the clip and FIG. 11B is a side view of the clip.

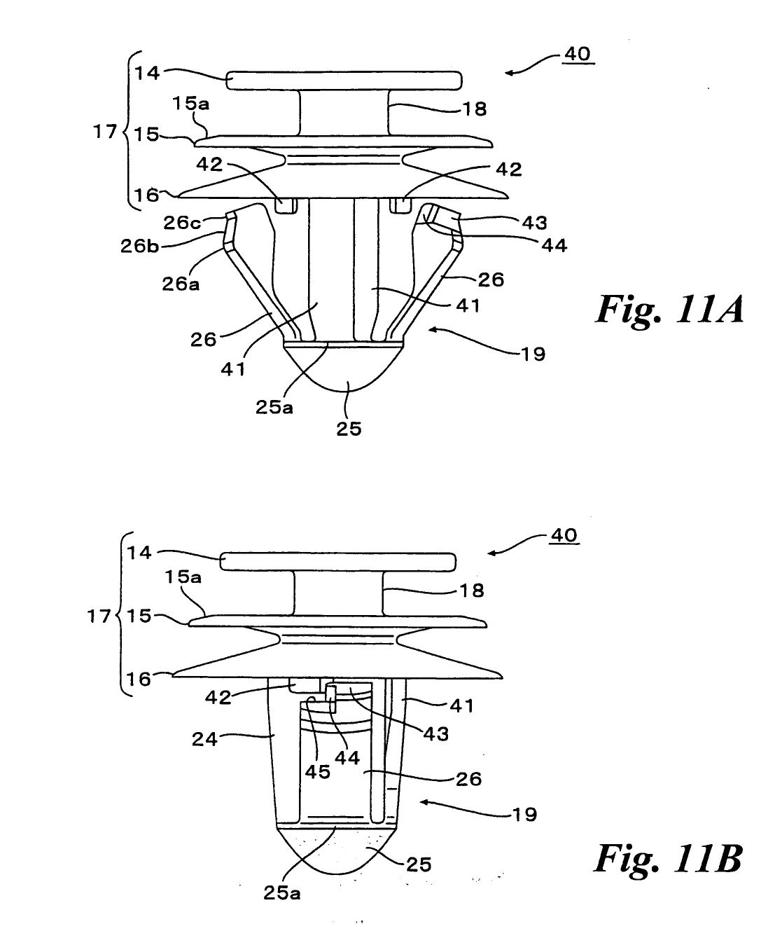

FIGS. 12A and 12B show a state in which elastic engagement pieces are brought into engagement with engagement walls which extend from a flange portion in the clip, of which FIG. 12A is a front view of the clip and FIG. 12B is a side view of the clip.

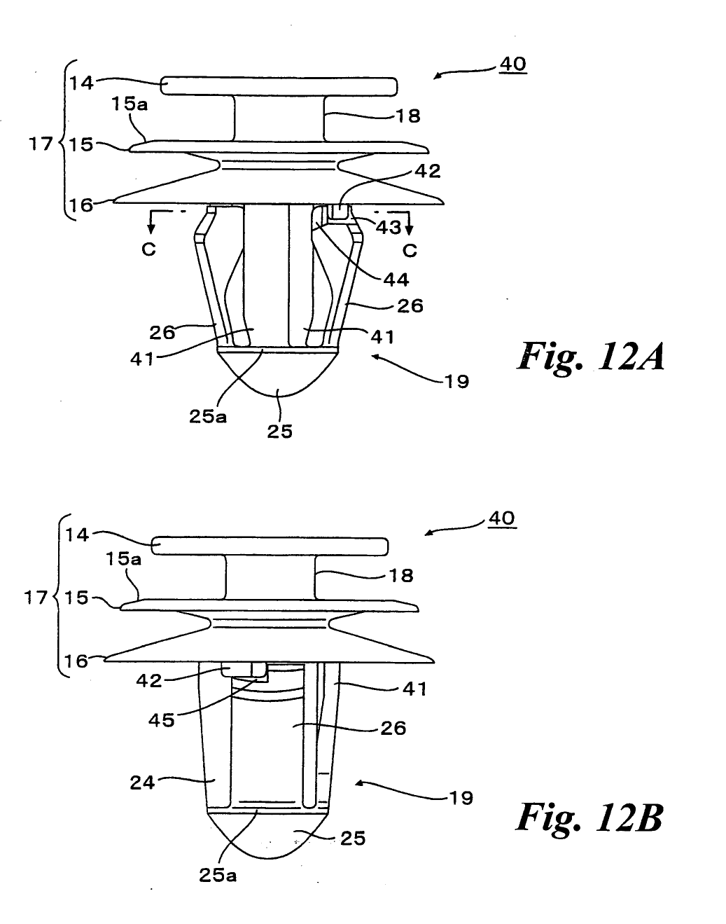

FIG. 13 is a sectional view of the clip taken along the line C-C and seen in a direction indicated by arrows attached thereto in FIGS. 12A and 12B.

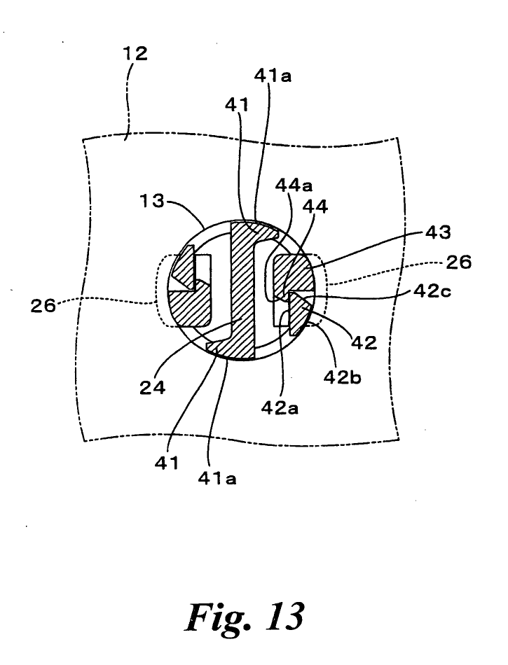

FIG. 14 is a partially cutaway perspective view of a clip according to a third embodiment of the invention.

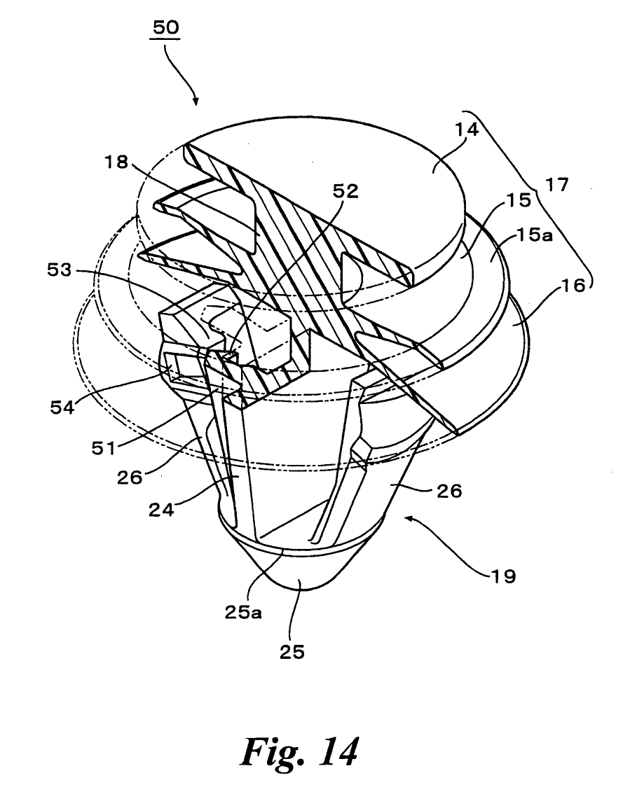

FIG. 15A is a front view of the clip and FIG. 15B is a side of the clip.

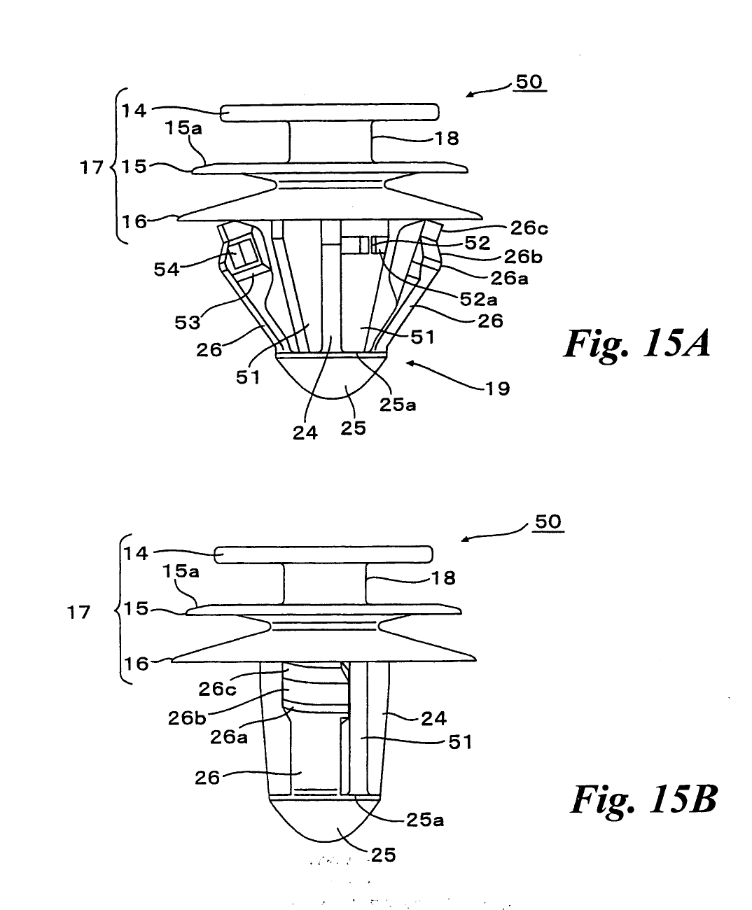

FIGS. 16A and 16B show a state in which elastic engagement pieces are brought into engagement with projecting pieces of a stem portion in the clip, of which FIG. 16A is a front view of the clip and FIG. 16B is a sectional view of the clip taken along the line D-D and seen in a direction indicated by arrows attached thereto in FIG. 16A.

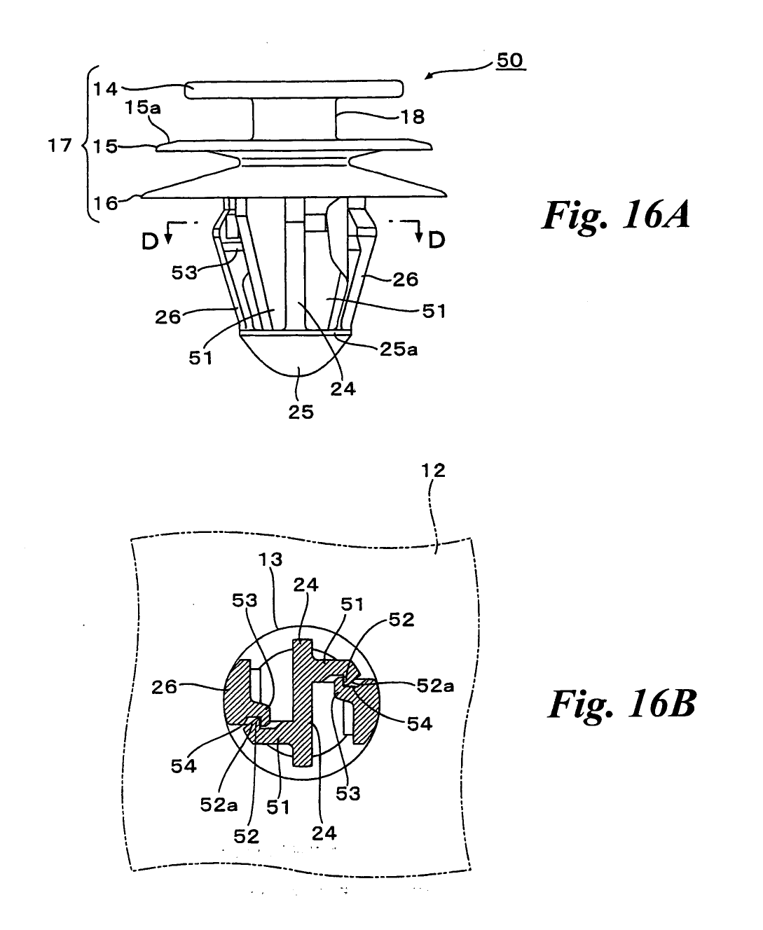

FIG. 17 is a partially cutaway perspective view of a clip according to a fourth embodiment of the invention.

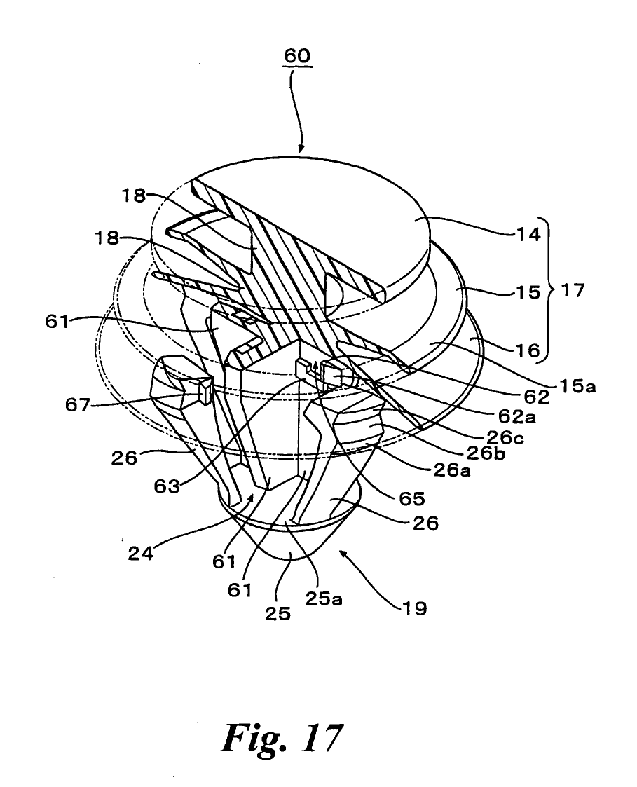

FIG. 18A is a front view of the clip and FIG. 18B is a sectional view of the clip taken along the line E-E and seen in a direction indicated by arrows attached thereto in FIG. 18A.

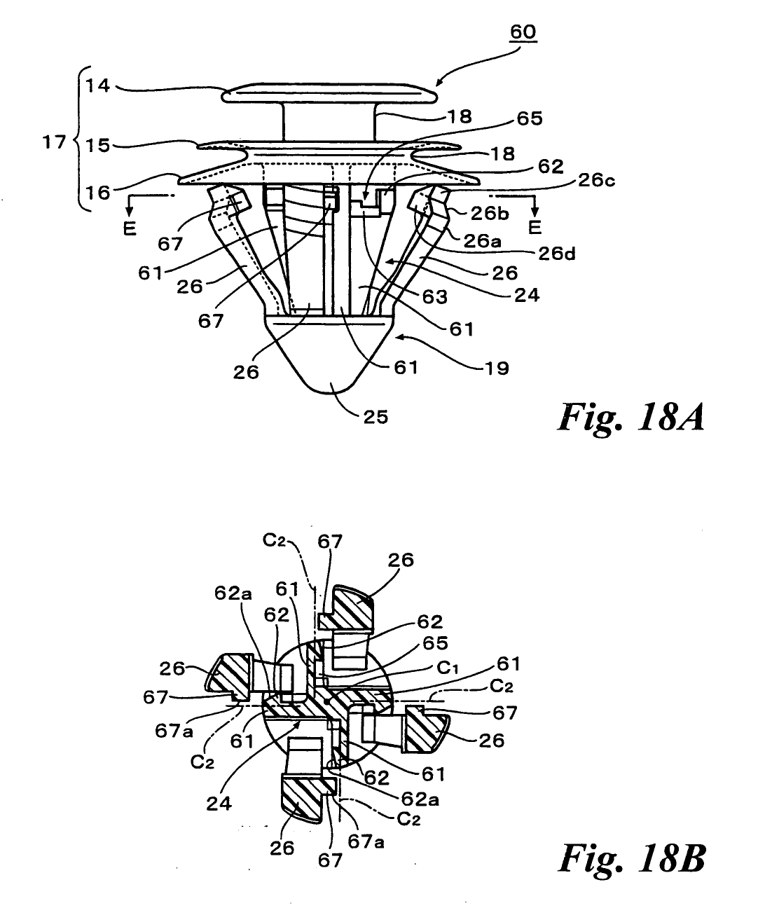

FIGS. 19A and 19B show a state in which elastic engagement pieces are caused to deflect inwards so as to be brought into engagement with engagement recesses of a stem portion in the clip, of which FIG. 19A is a front view of the clip and FIG. 19B is a sectional view of the clip taken along the line F-F and seen in a direction indicated by arrows attached thereto in FIG. 19A.

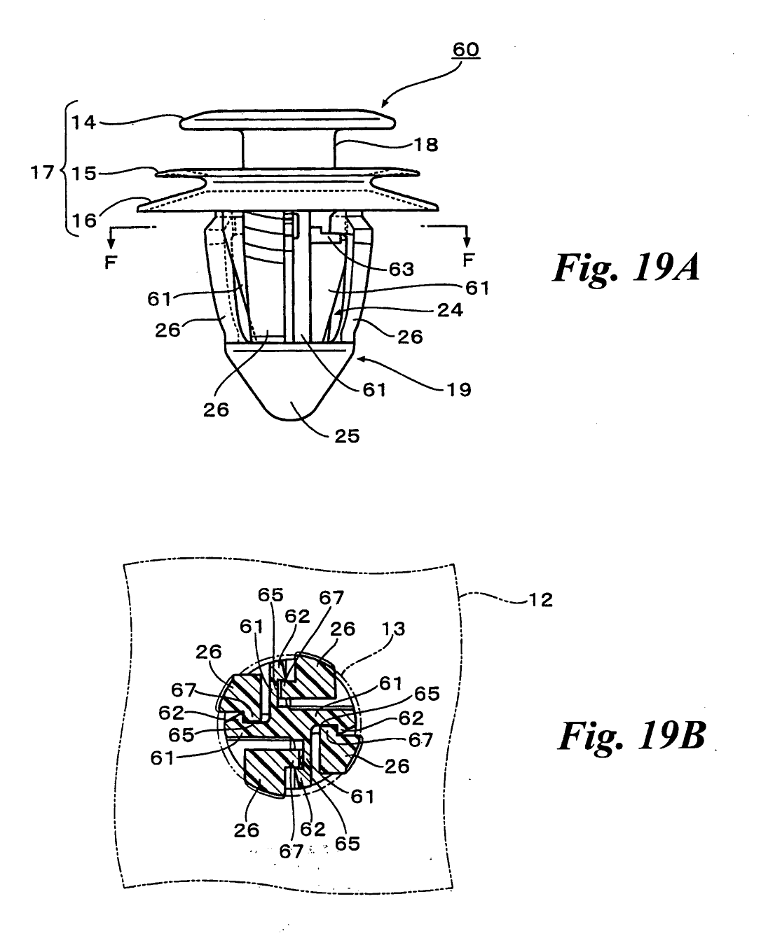

FIG. 20 is a partially cutaway perspective view of a clip according to a fifth embodiment of the invention.

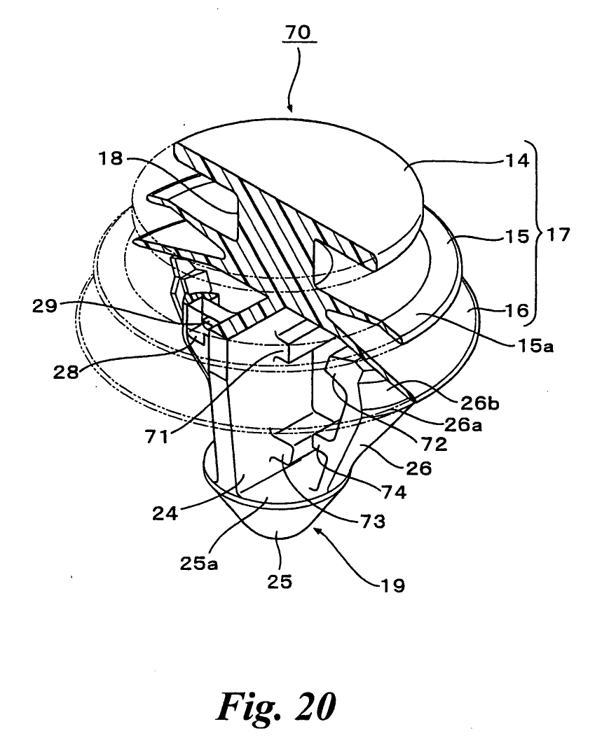

FIG. 21 is a front view of the clip.

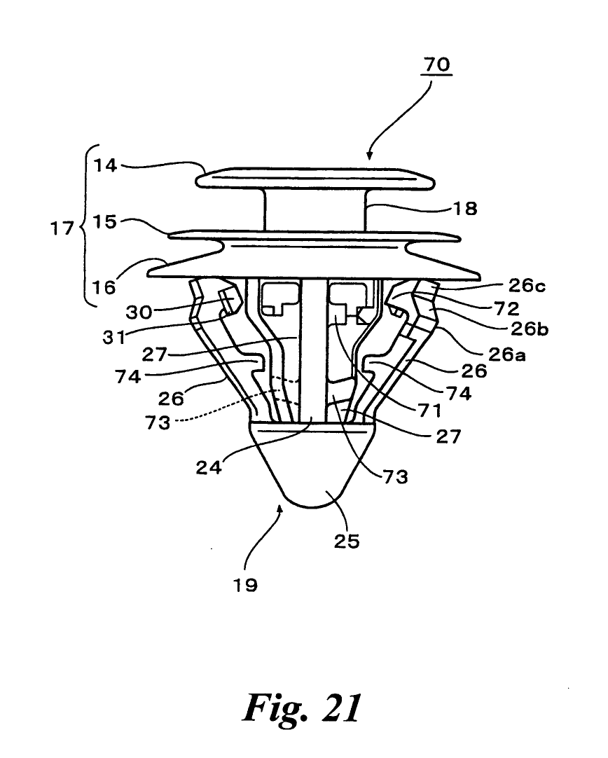

FIG. 22 is an explanatory diagram showing a state in which the clip is inserted into a mounting hole.

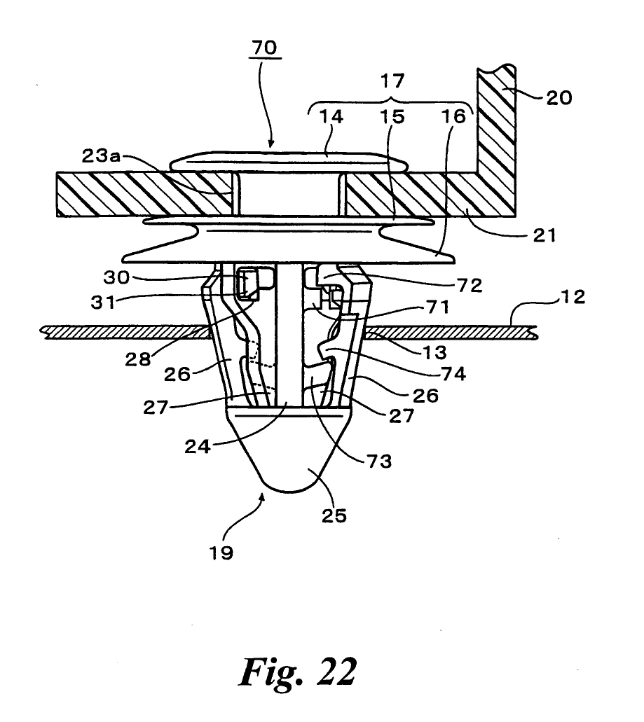

FIG. 23 is an explanatory diagram showing a state in which a trim board is fixed to a body panel by use of the clip.

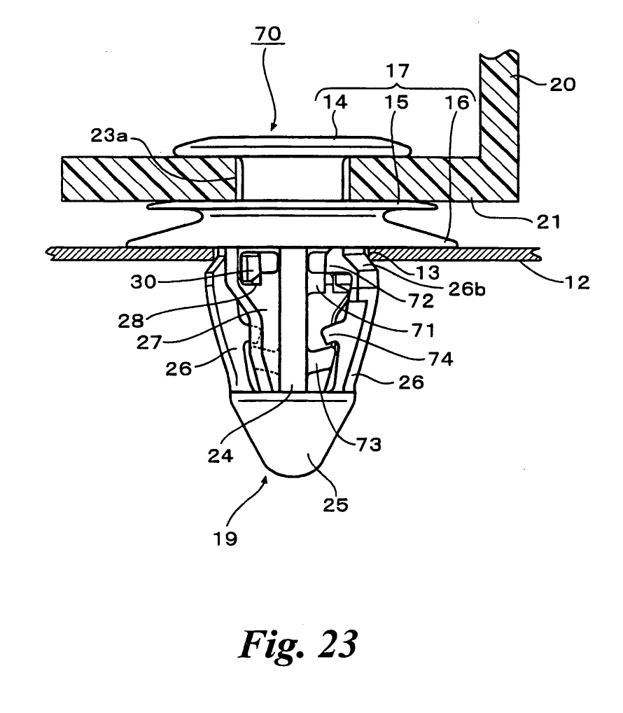

FIG. 24 is an explanatory diagram showing a state in which the clip is pulled out of the mounting hole.

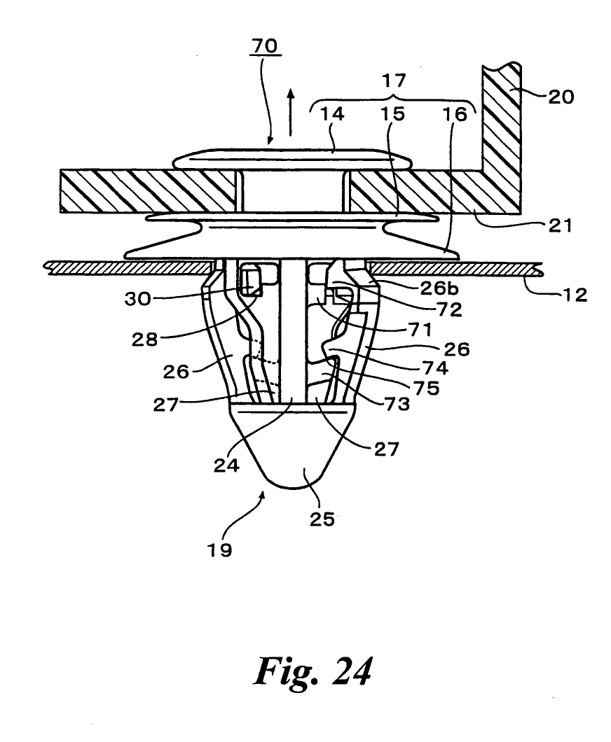

### DESCRIPTION OF REFERENCE NUMERALS

10, 40, 50, 60, 70 clip; 13 mounting hole; 16 flange portion (third flange portion); 25 distal end portion; 26 elastic engagement piece; 27, 51 projecting piece; 28 through hole; 29 catching portion; 30, 52 engagement projection; 54 engagement recess; 61 rib; 65 engagement recess; 67 engagement projection; stem-portion-side first projection; 72 engagement-piece-side first projection; 73 stem-portion-side second projection; 74 engagement-piece-side second projection.

1. A clip comprising:
a flange portion which is brought into abutment with a front surface of a mounting hole;
a stem portion which hangs downwards from a rear surface of the flange portion;
at least a pair of elastic engagement pieces which are extended from a distal end portion of the stem portion so as to expand obliquely upwards towards the flange portion; and
an expansion restriction mechanism which brings the elastic engagement pieces into engagement with the stem portion while permitting the elastic engagement pieces to deflect further inwards when the elastic engagement pieces deflect inwards with a given angle,
wherein the elastic engagement pieces deflect further inwards than an engagement position set by the expansion restriction mechanism so as to pass through the mounting hole and expand again on a rear surface side of the mounting hole so as to be brought into engagement with the mounting hole.

2. The clip of claim 1,
wherein a projecting piece is extended from the stem portion side along a plane on which one side of the elastic engagement piece moves when the elastic engagement piece deflects inwards, and
wherein the expansion restriction mechanism includes
an engagement recess which is formed on one of the projecting piece and the elastic engagement piece and
an engagement projection which is formed on the other of the projecting piece and the elastic engagement piece so as to be brought into engagement with the engagement recess.

3. The clip of claim 2,
wherein the engagement recess includes a through hole provided in the projecting piece, and
wherein the engagement projection projects from one side of the elastic engagement piece towards the projecting piece side.

4. The clip of claim 3,
wherein a catching portion is provided on an inner circumference of the through hole so as to protrude from an edge portion of the through hole which faces the elastic engagement piece into an inside of the through hole, and
wherein the engagement projection has
a first engagement plane which is brought into engagement with the inner circumference of the through hole to restrict the expansion of the elastic engagement piece and
a second engagement plane which is brought into engagement with the catching portion to restrict a shift of the elastic engagement piece in a direction substantially perpendicular to a diametrical direction of the elastic engagement piece.

5. A clip comprising:
a flange portion which is brought into abutment with a front surface of a mounting hole;
a stem portion which hangs downwards from a rear surface of the flange portion;
at least a pair of elastic engagement pieces which are extended from a distal end portion of the stem portion so as to expand obliquely upwards toward the flange portion; and
an expansion restriction mechanism which brings the elastic engagement pieces into engagement with the flange portion while permitting the elastic engagement pieces to deflect further inwards when the elastic engagement pieces deflect inwards with a given angle,
wherein the expansion restriction mechanism is formed between an engagement wall which is extended from the rear surface of the flange portion and the elastic engagement piece, and
wherein the elastic engagement pieces deflect further inwards than an engagement position set by the expansion restriction mechanism so as to pass through the mounting hole and expand again on a rear surface side of the mounting hole so as to be brought into engagement with the mounting hole.

6. The clip of claim 1,
wherein the stem portion includes four ribs which project radially outwards with respect to an axial center thereof,
wherein each of the four elastic engagement pieces is disposed between any two adjacent ribs of the four ribs, and
wherein the expansion restriction mechanism includes
an engagement recess which is formed on one of the rib and the elastic engagement piece and
an engagement projection which is formed on the other of the rib and the elastic engagement piece so as to be brought into engagement with the engagement recess.

7. The clip of claim 1,
wherein a stem-portion-side first projection is formed so as to extend from the stem portion towards the elastic engagement piece,
wherein an engagement-piece-side first projection is formed so as to extend from the elastic engagement piece towards the stem portion, and
wherein, when the stem portion and the elastic engagement pieces are inserted into the mounting hole, the stem-portion-side first projection and the engagement-piece-side first projection are not brought into engagement with each other due to a position of the engagement-piece-side first projection being shifted from a position of the stem-portion-side first projection in an axial direction of the stem portion, while when a force is applied to pull out the stem portion and the elastic engagement pieces from the mounting hole, the stem-portion-side first projection and the engagement-piece-side first projection are brought into engagement with each other due to the length of the elastic engagement piece being shortened by the elastic engagement piece being bent.

8. The clip of claim 7,
wherein a stem-portion-side second projection is formed on the stem portion so as to extend towards the elastic engagement piece in a position lying closer to a distal end of the stem portion than the stem-portion-side first projection,
wherein an engagement-piece-side second projection is formed on the elastic engagement piece in a position lying closer to a proximal end of the elastic engagement piece than the engagement-piece-side first projection, and
wherein, when the elastic engagement piece is defected inwards, the engagement-piece-side second projection is disposed closer to the proximal end of the stem portion than the stem-portion-side second projection, while when the stem portion and the elastic engagement pieces are attempted to be forcibly pulled out of the mounting hole, the engagement-piece-side second projection is brought into abutment with the stem-portion-side second projection due to the length of the elastic engagement piece being shortened by the elastic engagement piece being bent.

9. The clip of claim 8,
wherein an abutment plane between the engagement-piece-side second projection and the stem-portion-side second projection is made into an inclined plane which is inclined radially outwards of the clip and gradually towards the proximal end of the stem portion.
